(19) United States
(12) Patent Application Publication
(10) Pub. No.: US 2018/0254590 A1
(43) Pub. Date: Sep. 6, 2018

(54) LAMP BASE ADAPTER

(71) Applicant: Novin Enterprises LLC., San Jose, CA (US)

(72) Inventors: Eliah David Novin, San Jose, CA (US); Wade Earl Novin, Sherman Oaks, CA (US)

(73) Assignee: Novin Enterprises LLC., San Jose, CA (US)

(21) Appl. No.: 15/908,743

(22) Filed: Feb. 28, 2018

Related U.S. Application Data
(60) Provisional application No. 62/465,489, filed on Mar. 1, 2017.

(51) Int. Cl. H01R 31/06; F21V 23/06; H01R 13/512; H01R 12/75; H01R 13/41

(52) U.S. Cl. CPC H01R 31/06; F21V 23/06; H01R 13/41; H01R 12/75; H01R 13/512

(57) ABSTRACT

The present disclosure provides example lamp base adaptors as well as systems and methods for manufacturing the same. A lamp base adaptor, in some implementations, comprises: a molded base adaptor, a pair of connection wires including a first wire and a second wire, a pair of blades including a first blade and a second blade, one or more threaded inserts securing the molded base adaptor; and a printed circuit board connector connected to the first wire and the second wire. The first blade is connected with the first wire and the second blade is connected with the second wire; the pair of blades are partially, but not fully, inserted into the molded base adaptor.

### REFERENCE TO RELATED APPLICATIONS

This application claims the benefit of U.S. Provisional Patent Application Ser. No. 62/465,489, filed Mar. 1, 2017, and entitled “Lamp Base Adaptor”, which is hereby incorporated by reference in its entirety.

### TECHNICAL FIELD

The present disclosure generally relates to retrofit lighting and LED lighting and more specifically to a lamp base adaptor.

### BACKGROUND

For reasons such as energy efficiency, LED based lighting products are rapidly replacing incandescent and filament based light bulbs, among others. The installed base of lighting fixtures uses standard lamp sockets and receivers that match those of incandescent and filament based light bulbs. Due to the high waste heat generated by conventional bulbs, lamp bases may need to be made of materials that maintain structural integrity and dielectric breakdown strength at very high temperatures, such as ceramics. These materials are often expensive. Further, lamp bases made these ways are typically manufactured as an integrated part of the lamps and are thus not available for purchase as a separate component.

The above identified problems are reduced or eliminated by the apparatuses disclosed in the present disclosure.

### BRIEF DESCRIPTION OF THE DRAWINGS

FIG. 1 is a block diagram illustrating a lamp base adaptor with over-molded blades and a crimped-wire output connection, in accordance with some implementations.

FIG. 2 is a block diagram illustrating a side view of a lamp base adaptor with over-molded blades and a crimped-wire output connection, in accordance with some implementations.

FIG. 3 is a block diagram illustrating various components of a lamp base adaptor, in accordance with some implementations.

FIG. 4 is a block diagram illustrating a lamp base adaptor with over-molded flat blades, in accordance with some implementations.

FIG. 5 is a block diagram illustrating various components of a lamp base adaptor with over-molded flat blades, in accordance with some implementations.

FIG. 6 is a plan view of a flat blade in accordance with some implementations.

FIG. 7 is a flowchart illustrating an example method for manufacturing a lamp base adaptor.

FIG. 8 is a block diagram illustrating an example computer system for manufacturing a lamp base adaptor.

The following reference numbers refer to the following components: 10 refers to a molded base adaptor, 20 refers to a connection wire, 30 refers to one or more blades, 40 refers to one or more threaded inserts, 50 refers to a Printed Circuit Board (PCB) connector, 60 refers to one or more connection terminals or receptacles, 70 refers to one or more mounting holes in the molded base, and 80 refers to a blade over-mold retention feature.

Embodiments of the present disclosure and their advantages are best understood by referring to the detailed description that follows. It should be appreciated that like reference numerals are used to identify like elements illustrated in one or more of the figures; showings therein are for purposes of illustrating embodiments of the present disclosure and not for purposes of limiting the same.

### SUMMARY

Embodiments of lamp base adaptors, as well as method and computer executable instructions for manufacturing the same, are provided in the present disclosure.

A lamp base adaptor, in some implementations, comprises: a molded base adaptor, a pair of connection wires including a first wire and a second wire, a pair of blades including a first blade and a second blade, one or more threaded inserts securing the molded base adaptor; and a printed circuit board connector connected to the first wire and the second wire. The first blade is connected with the first wire and the second blade is connected with the second wire; the pair of blades are partially, but not fully, inserted into the molded base adaptor.

The lamp base adaptor, in some implementations, further comprises: a pair of connection terminals; the pair of connection terminals includes a first terminal and a second terminal.

In some implementations, the first terminal is connected with the first wire and the first blade, and the second terminal is connected with the second wire and the second blade.

In some implementations, the first terminal and the second terminal are of an L shape.

In some implementations, the molded base adaptor includes a base piece and a cover piece; the cover piece is configured to be secured to the base piece using the one or more threaded inserts.

In some implementations, the one or more threaded inserts include two threaded inserts.

In some implementations, the one or more threaded inserts include a single threaded insert.

In some implementations, the molded base adaptor is made of a molding material having low heat resistance.

In some implementations, the molding material includes polymer.

In some implementations, the molded base adaptor is made of a light weight molding material.

In some implementations, the light weight molding material includes plastics.

In some implementations, the molded base adaptor is made of ceramics.

In some implementations, the molded base adaptor is made using a 3D printing process.

In some implementations, the molded base adaptor is made using an injection molding process.

In some implementations, the pair of blades includes a blade over-mold retention feature.

In some implementations, the blade over-mold retention feature includes protrusions of blades or indentations in the blades around which the over-molding material will flow to help retain the blades in the molded base adapter.

In some implementations, the molded base adaptor includes two rounded ends.

In some implementations, the molded base adaptor is detachable form the lamp base adaptor.

A computer-implemented method for manufacturing the lamp base adaptors as described in any of the implementations above.

A non-transitory computer readable medium comprising computer executable instructions stored thereon, which, when executed by one or more computers, cause a machine to manufacture the lamp base adaptors as described in any of the implementations above.

### DETAILED DESCRIPTION

The present disclosure provides example lamp base adaptors as well as systems and methods for manufacturing the same. Lamp base adaptors described in the present disclosure enables retrofit lighting and LED lights to be directly connected to existing or new lighting fixtures. These adapters conform to conventional light bulb base standards on the input side and provide wire lead outputs or standard connector terminals on the output side.

The technologies described in the present disclosure can provide the following technical advantages. First, from a manufacturer's perspective, a lamp base adaptor as described is separate (before installation) and detachable (after installation) onto a lamp fixture, providing more flexibility in terms of sales and manufacturing. Second, a lamp base as described may be made of plastics, rather than traditional high-temperature resistant ceramics, reducing manufacturing cost and increasing potential profit. Third, from a user's perspective, a user can replace the lamp base adaptor without replacing the lamp fixture or the lamp. Fourth, such as an adaptor makes it less onerous and more cost effective to retrofit LED light bulbs onto incandescent and filament based light fixtures.

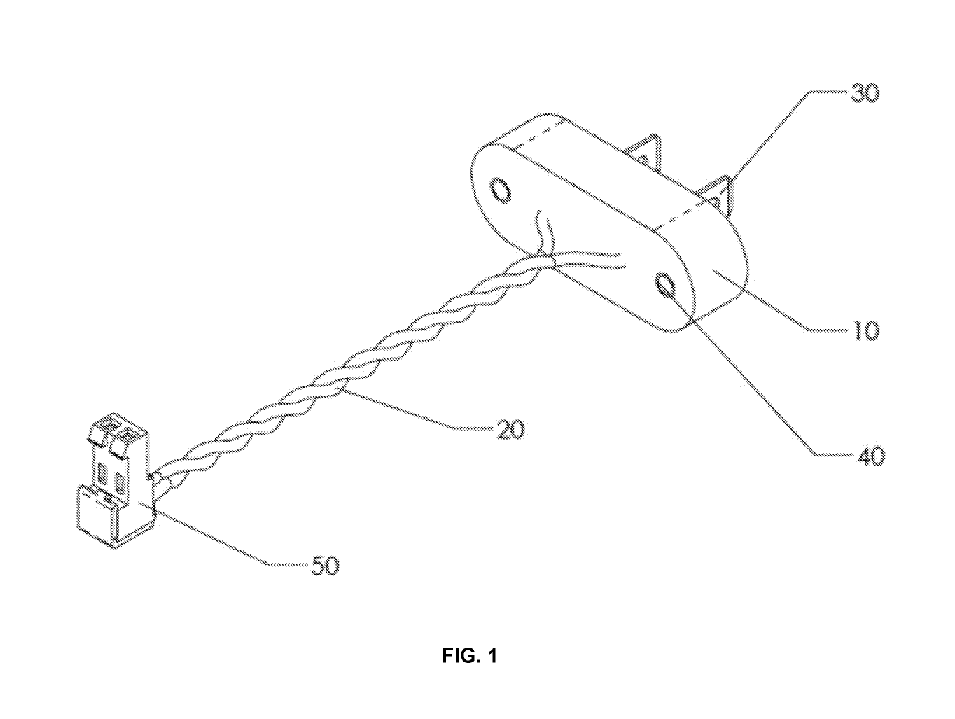

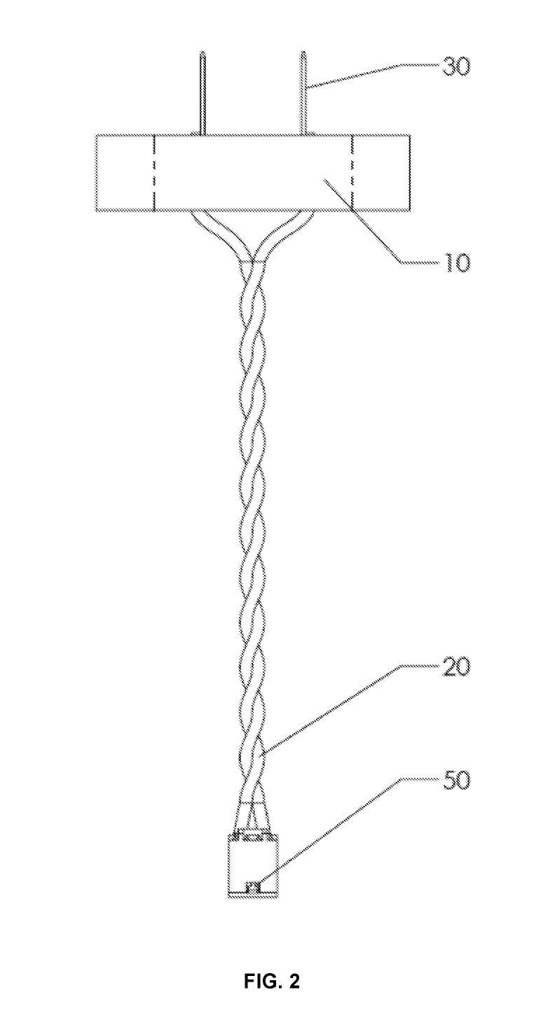

FIG. 1 is a block diagram illustrating a lamp base adaptor with over-molded blades and a crimped-wire output connection, in accordance with some implementations. FIG. 2 is a block diagram illustrating a side view of the lamp base adaptor illustrated in FIG. 1, in accordance with some implementations.

The lamp base adaptor addresses the need for retrofit and new LED lamps to match the connectivity of the conventional bulbs they are replacing. In order to conveniently replace the bulbs with a retrofit or new LED lamp, the lamp should have an adaptor connecting to the fixture that matches the lamp base of the bulb being replaced. Without such an adaptor, the light fixture may require significant modifications to an alternate connection method at the cost of additional expertise and expense.

The significant reduction in energy used by LED lamps compared to conventional bulbs, sometimes one-tenth or more, results in significantly lower temperatures at the lamp base. Thus, the lamp base adaptor may be made of polymer materials, instead of the conventional ceramic materials, and through more efficient and cost effective manufacturing processes, such as 3D printing or injection molding. The material from which the lamp base adaptor may be made may be selected in accordance with manufacturing costs as well as relevant safety standards, e.g. UL, or regulatory requirements.

The lamp base adaptor includes an input side that conforms to predefined or pre-existing lamp base dimensions. To allow greater flexibility in terms of connecting different types of LED driver boards or other retrofit lamps, the output side may terminate with bare wires, suitably shaped terminal blades for the use with disconnects or to an appropriate connector for direct plug into the lamp input itself. The lamp base adaptor, in some implementations, includes features and requirements needed to meet applicable safety and regulatory requirements, e.g., heat, pull-out or humidly resistance.

The lamp base adaptor may connect retrofit lighting and LED lights to both existing and new light fixtures which employ a standard lamp socket such that there is little or no modification to the fixture required. Example lamp fixtures to which the lamp base adaptor may be connected are described in U.S. patent application Ser. No. 15/081,581 and U.S. Provisional Patent Application Ser. No. 62/139,638.

The lamp base adaptor may be made to be compatible with existing wiring and power connections as well as lighting control and dimming equipment. For example, in one embodiment, the lamp adaptor is used to connect LED retrofit lamps that replace Par64 and Par56 incandescent bulbs.

The input side of the lamp base adaptor may be made to be compatible with standard lamp holders or sockets found commercially available either individually or as installed in fixtures. In one embodiment this lamp socket or holder is a mogul socket or a socket intended to receive a lamp base that conforms to the IEC 60061-1 Sheet 7004-154-2 specification

The base of the lamp base adaptor may be manufactured using moldable or 3D printable polymers, as well as moldable polymers reinforced with fibers such as glass, carbon, or aramids to form a composite material. The formed polymer conforms to dimensional standards required to mate with appropriate lamp sockets or holders. Once molded, the polymer or composite material acts to hold conducting blades, pins or sockets in the correct orientation, spacing and height to conform to such standards.

In some embodiments, the conducting blades are stamped or formed at one end to meet the appropriate lamp connection standard. On the opposite end of the blade, a wire crimping feature is stamped or formed in order to crimp the blade on the bare wire ends of a gauge or diameter that is correctly sized for the current it carries. The combined blade with crimped wire is then over-molded with polymer or composite material as described.

Different embodiments utilize a flat, conducting blade, also stamped or formed on one end to meet the lamp connection standard, and stamped formed on the other end such as to provide connectivity to available connection terminals or receptacles. Further, in some embodiments, features are added to the blade and are intended to remain embedded in the over-molded base polymer or composite material. These features include protrusions of metal or indentations in the metal such that the over-mold material will flow around or in the features and act to help retain the blades in the over-mold. The additional retention provided by such features is in place to enhance blade pull out performance pursuit to meeting applicable safety standards.

The lamp base adaptor may be mounted to lamp surfaces such as sheet metal and plastic or integrated to other enclosure components such as power supply enclosures. This mountable aspect provides further advantages over traditional ceramic lamp base which may not be so mounted in conformance to applicable safety standards. The use of a polymer or composite material for the base, as explained in the present disclosure, also avails the use of efficient molding manufacturing techniques such as molded-in, heat-staked or ultrasonic welded threaded inserts. These inserts may be used to attach the lamp base adaptor to the suitable mounting surface.

The lamp base adaptor, in some embodiments, includes a base adaptor 10 made of printed or molded material, such as polymer or polymer composite, that conforms to the required lamp base standard and supports, positions and orients the blades 30. The blades 30 may be stamped, formed, or pressed, using a suitable manufacturing process and designed to conform to the required lamp base standard.

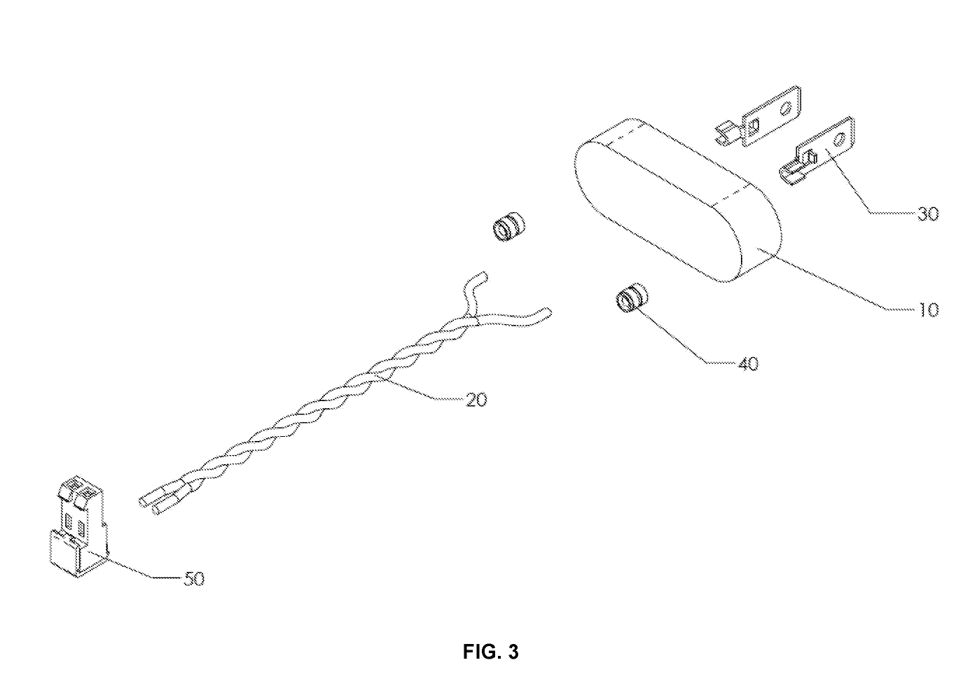

In some embodiments, the blades are designed with a wire crimping feature that allows the connection wire 20 to be held firmly in place at the blade after it has been electrically connected by soldering. An example blade 30 is shown in FIG. 3.

In some embodiments, these wires are soldered and crimped to the blades and then placed in an appropriate molding tool. The molding process over-molds the blades and wire into the molded base adapter. This over-mold process may, in alternate embodiments, be processed through injection, resin-transfer, or any appropriate molding process such that the end result is a dimensionally conforming assembly such as the assembly shown in FIG. 1. In this embodiment, the method for attaching the assembly to a flat surface uses over-molded threaded inserts 40 that are then used with standard screws or fasteners. The result of the molding process is a solid molded base adapter 10 with permanently embedded blades 30 with wires 20 attached to them, and permanently embedded fastening features 40.

In some embodiments, such as the one shown in FIG. 1, a standard printed circuit board connector 50 terminates the output end of the connection wires 20 such that it can connect to the matching circuit board input header. In alternate embodiments, this connector may not be present and the wires are left bare such that they allow direct connection to a board or power supply input.

FIG. 3 is a block diagram illustrating various components of a second example lamp base adaptor, in accordance with some implementations.

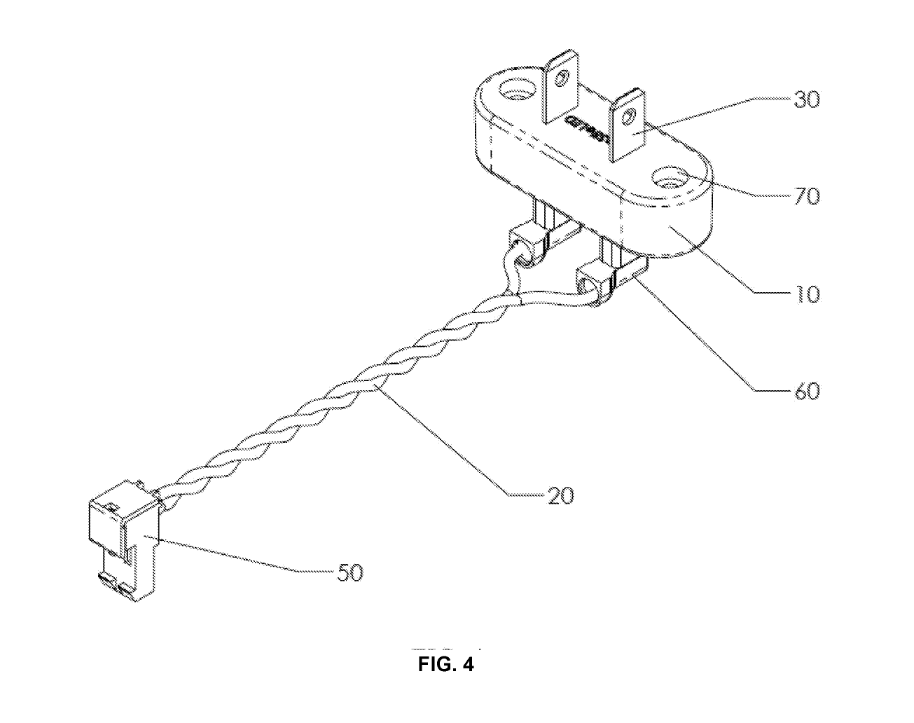

FIG. 4 is a block diagram illustrating the second example lamp base adaptor with over-molded flat blades, in accordance with some implementations.

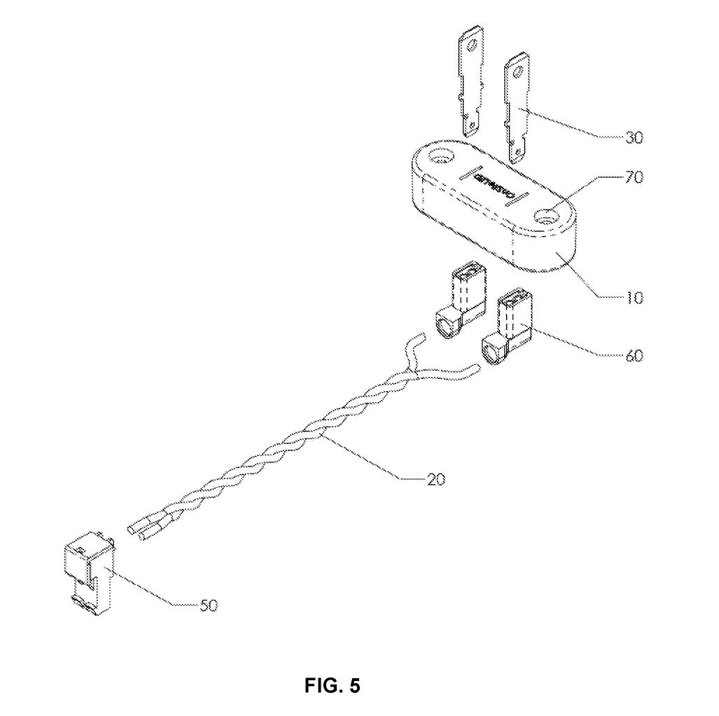

FIG. 5 is a block diagram illustrating various components of the second example, in accordance with some implementations.

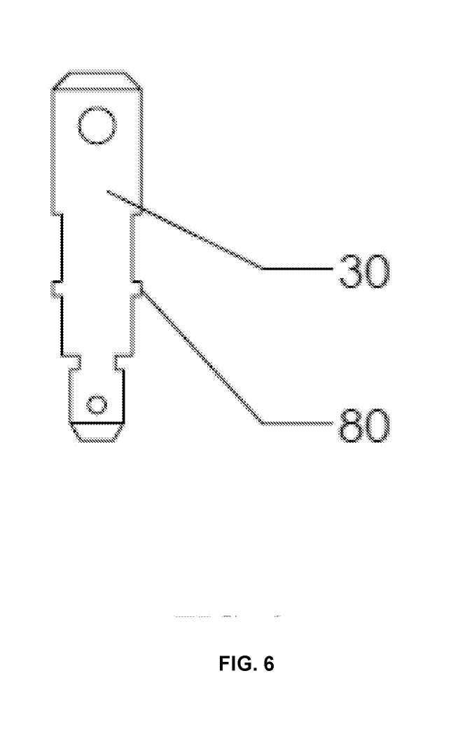

As shown in FIGS. 3-5, the blades 30 are formed as a flat part (also referred to as a flat blade, for example with reference to FIG. 6) with the input end conforming to one or more predefined or pre-existing lamp connection standard and the output end to provide connectivity to predefined or pre-existing connection terminals or receptacles 60.

In some embodiments, blade over-mold retention features 80 are included in the shape of the blade. These features may be protrusions of metal or indentations in the metal around which the over-molding material will flow to help retain the blades in the molded base adapter 10. The features 80 may enhance blade pull out performance. In one embodiment, mounting holes 70 are molded into the base adapter 10 using appropriate molding tools, such as core pins. These holes allow the assembly to be attached to a flat surface when used with standard screws or fasteners. The result of the molding process is a solid molded base adapter 10 with permanently embedded blades 30 having the lamp connection standard shape on the input end and an appropriate shape for the use connection terminal on the output end. Connection terminals or receptacles 60 facilitate the connection of the blades to the wires 20 and then to a printed circuit board connector 50 or bare wire ends for direct connection to a board or power supply input.

FIG. 6 is a plan view of a flat blade in accordance with some implementations.

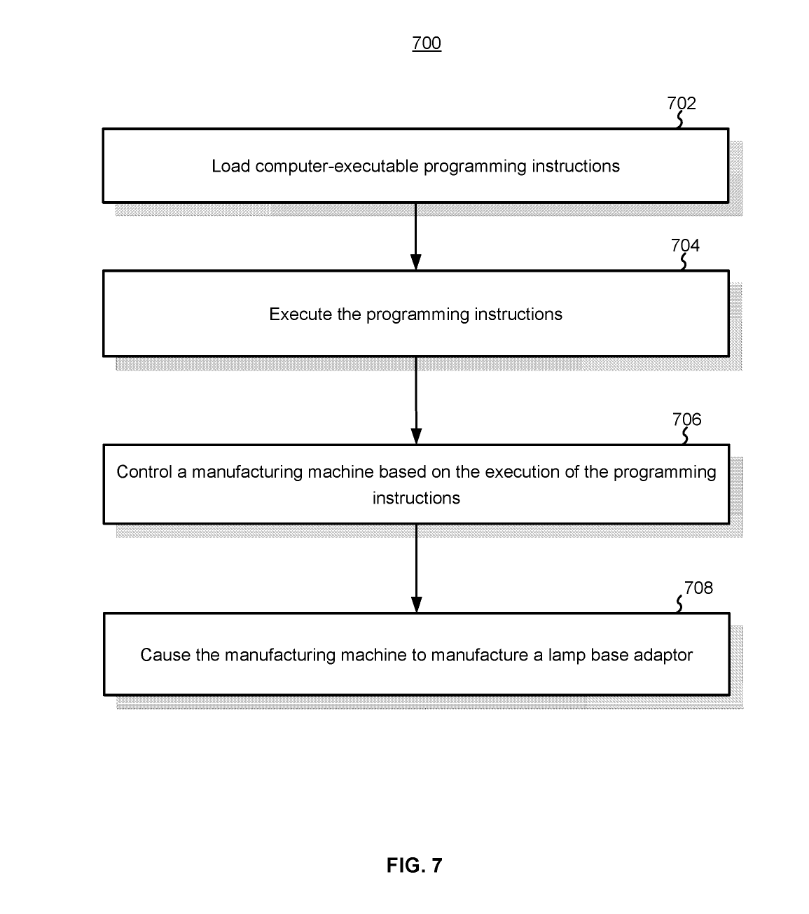

FIG. 7 is a flowchart illustrating an example computer-implemented method 700 for manufacturing a lamp base adaptor. The computer system 800, when properly programmed, can execute the method 700.

In some implementations, the method 700 includes using a computer to load (702) computer-executable programming instructions from a non-volatile memory of the computer to a volatile memory of the computer.

After loading the programming instructions, the computer may execute (704) the programming instructions using the volatile memory.

Based on the execution of the programming instructions, the computer may control (706) a manufacturing machine, for example, a cutting machine, a molding machine, or a pressing machine.

By controlling the manufacturing machine, the computer causes (708) the manufacturing machine to manufacture a lamp base adaptor as described in one or more of the implementations disclosed in the present disclosure.

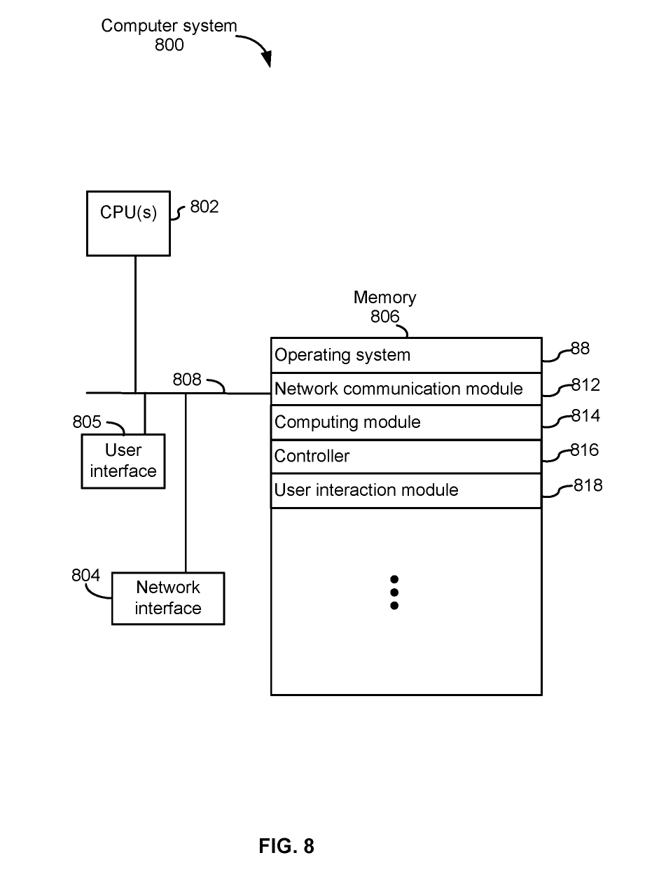

FIG. 8 is a block diagram illustrating an example computer system 800 for manufacturing a lamp base adaptor. The computer system 800 in some implementations includes one or more processing units CPU(s) 802 (also referred to as processors), one or more network interfaces, optionally a user interface, a memory 806, and one or more communication buses 810 for interconnecting these components. The communication buses 810 optionally include circuitry (sometimes called a chipset) that interconnects and controls communications between system components. The memory 806 typically includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. The memory 806 optionally includes one or more storage devices remotely located from the CPU(s) 802. The memory 806, or alternatively the non-volatile memory device(s) within the memory 806, comprises a non-transitory computer readable storage medium. In some implementations, the memory 806 or alternatively the non-transitory computer readable storage medium stores the following programs, modules and data structures, or a subset thereof:
an operating system 810 (e.g., an embedded Linux operating system), which includes procedures for handling various basic system services and for performing hardware dependent tasks;
a network communication module 812 for connecting the computer system with a manufacturing machine via one or more network interfaces (wired or wireless);
a computing module 814 for executing programming instructions;
a controller 816 for controlling a manufacturing machine in accordance with the execution of programming instructions; and
a user interaction module 818 for enabling a user to interact with the computer system 800.

One or more of the above identified elements may be stored in one or more of the previously mentioned memory devices, and correspond to a set of instructions for performing a function described above. The above identified modules or programs (e.g., sets of instructions) need not be implemented as separate software programs, procedures or modules, and thus various subsets of these modules may be combined or otherwise re-arranged in various implementations. In some implementations, the memory 806 optionally stores a subset of the modules and data structures identified above. Furthermore, the memory 806 may store additional modules and data structures not described above.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the implementation(s). In general, structures and functionality presented as separate components in the example configurations may be implemented as a combined structure or component. Similarly, structures and functionality presented as a single component may be implemented as separate components. These and other variations, modifications, additions, and improvements fall within the scope of the implementation(s).

It will also be understood that, although the terms “first,” “second,” etc. may be used herein to describe various elements, these elements should not be limited by these terms. These terms are only used to distinguish one element from another. For example, a first blade could be termed a second blade, and, similarly, a second blade could be termed a first blade, without changing the meaning of the description, so long as all occurrences of the “first blade” are renamed consistently and all occurrences of the “second blade” are renamed consistently. The first blade and the second blade are both blades but they are not the same blade.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

The foregoing description included example systems, methods, techniques, instruction sequences, and computing machine program products that embody illustrative implementations. For purposes of explanation, numerous specific details were set forth in order to provide an understanding of various implementations of the inventive subject matter. It will be evident, however, to those skilled in the art that implementations of the inventive subject matter may be practiced without these specific details. In general, well-known instruction instances, protocols, structures and techniques have not been shown in detail.

The foregoing description, for purpose of explanation, has been described with reference to specific implementations. However, the illustrative discussions above are not intended to be exhaustive or to limit the implementations to the precise forms disclosed. Many modifications and variations are possible in view of the above teachings. The implementations were chosen and described in order to best explain the principles and their practical applications, to thereby enable others skilled in the art to best utilize the implementations and various implementations with various modifications as are suited to the particular use contemplated.

What is claimed is:

1. A lamp base adaptor, comprising:
a molded base adaptor,
a pair of connection wires including a first wire and a second wire,
a pair of blades including a first blade and a second blade, wherein
the first blade is connected with the first wire and the second blade is connected with the second wire;
the pair of blades is partially, but not fully, molded into the molded base adaptor;
one or more threaded inserts securing the molded base adaptor; and
a printed circuit board connector connected to the first wire and the second wire.

2. The lamp base adaptor of claim 1, further comprising: a pair of connection terminals, wherein the pair of connection terminals includes a first terminal and a second terminal.

3. The lamp base adaptor of claim 2, wherein the first terminal is connected with the first wire and the first blade, and the second terminal is connected with the second wire and the second blade.

4. The lamp base adaptor of claim 3, wherein the first terminal and the second terminal are of an L shape.

5. The lamp base adaptor of claim 1, wherein the molded base adaptor includes a base piece and a cover piece, wherein the cover piece is configured to be secured to the base piece using the one or more threaded inserts.

6. The lamp base adaptor of claim 5, wherein the one or more threaded inserts include two threaded inserts.

7. The lamp base adaptor of claim 5, wherein the one or more threaded inserts include a single threaded insert.

8. The lamp base adaptor of claim 1, wherein the molded base adaptor is made of a molding material having low heat resistance.

9. The lamp base adaptor of claim 8, wherein the molding material includes polymer.

10. The lamp base adaptor of claim 1, wherein the molded base adaptor is made of a light weight molding material.

11. The lamp base adaptor of claim 10, wherein the light weight molding material includes plastics.

12. The lamp base adaptor of claim 1, wherein the molded base adaptor is made of ceramics.

13. The lamp base adaptor of claim 1, wherein the molded base adaptor is made using a 3D printing process.

14. The lamp base adaptor of claim 1, wherein the molded base adaptor is made using an injection molding process.

15. The lamp base adaptor of claim 1, wherein the pair of blades includes a blade over-mold retention feature.

16. The lamp base adaptor of claim 15, wherein the blade over-mold retention feature includes protrusions of blades or indentations in the blades around which the over-molding material will flow to help retain the blades in the molded base adapter.

17. The lamp base adaptor of claim 16, wherein the molded base adaptor includes two rounded ends.

18. The lamp base adaptor of claim 1, wherein the molded base adaptor is detachable form the lamp base adaptor.

19. A method for manufacturing the lamp base adaptor of claim 1.

20. A non-transitory computer readable medium comprising computer executable instructions stored thereon, which, when executed by one or more computers, cause a machine to manufacture the lamp base adaptor of claim 1.
